(19) United States
(12) Patent Application Publication
(10) Pub. No.: US 2021/0245055 A1
(43) Pub. Date: Aug. 12, 2021

(54) AUGMENTED REALITY GAMING SYSTEM AND METHOD EMPLOYING REAL WORLD GEOLOCATION PARAMETERS

(71) Applicants: Carlos R. Villamar, Falls Church, VA (US); Joshua M. Lopez, Austin, TX (US); Jan Willem Olger Valentijn Kerseboom, Amstelveen (NL)

(72) Inventors: Carlos R. Villamar, Falls Church, VA (US); Joshua M. Lopez, Austin, TX (US); Jan Willem Olger Valentijn Kerseboom, Amstelveen (NL)

(21) Appl. No.: 17/170,767

(22) Filed: Feb. 8, 2021

Related U.S. Application Data
(60) Provisional application No. 62/971,961, filed on Feb. 8, 2020.

(51) Int. Cl. A63F 13/577; A63F 13/216; A63F 13/35

(52) U.S. Cl. CPC A63F 13/577; A63F 13/35; A63F 13/216

(57) ABSTRACT

A system, method and computer program product for employing augmented reality gaming, including real world geolocation parameters, includes a plurality of gaming client devices; a game server and a geolocation system coupled thereto over a communication network; and gaming resources including a virtual missile object launched by the gaming client devices. The geolocation system determines a 3D real world location of each of the gaming client devices, which are positioned by a user in 3D space so as to launch the missile object at an angle and direction estimated to hit another of the gaming client devices. The game server calculates a real world point of impact based on the angle and direction estimates, and determines if there are hits or misses based on the calculated point of impact and the 3D real world locations. The game server displays hits and misses on the gaming client devices.

### CROSS REFERENCE TO RELATED DOCUMENTS

The present invention is claims priority to U.S. Provisional Patent Application Ser. No. 62/971,961 of BELL et al., entitled “AUGMENTED REALITY GAMING SYSTEM AND METHOD EMPLOYING REAL WORLD GEOLOCATION PARAMETERS,” filed on 8 Feb. 2020, now pending, the entire disclosure of which is hereby incorporated by reference herein.

### BACKGROUND OF THE INVENTION

### Field of the Invention

The present invention generally relates to systems and methods for online gaming, and more particularly to systems and methods for employing augmented reality gaming, including real world geolocation parameters, and the like.

### Discussion of the Background

In recent years, systems and methods for online gaming. However, such systems and methods lack efficient employment of augmented reality gaming, including real world geolocation parameters, and the like.

### SUMMARY OF THE INVENTION

Therefore, there is a need for methods and systems that address the above, and other problems. The above and other problems are addressed by the illustrative embodiments of the present invention, which provide systems and methods for employment of augmented reality gaming, including real world geolocation parameters, and the like.

Accordingly, in illustrative aspects of the present invention there is provided a system, method and computer program product for employing augmented reality gaming, including real world geolocation parameters, includes a plurality of gaming client devices; a game server and a geolocation system coupled thereto over a communication network; and gaming resources including a virtual missile object launched by the gaming client devices. The geolocation system determines a 3D real world location of each of the gaming client devices, which are positioned by a user in 3D space so as to launch the missile object at an angle and direction estimated to hit another of the gaming client devices. The game server calculates a real world point of impact based on the angle and direction estimates, and determines if there are hits or misses based on the calculated point of impact and the 3D real world locations. The game server displays hits and misses on the gaming client devices.

The gaming client devices include PCs, smart phones, and laptop clients.

The geolocation system includes global positioning systems, cell tower triangulation systems, Galileo systems, Glonass systems, Google location services systems.

The gaming resources include arsenals, tradables, supplies, items, countermeasures, munitions, real and virtual currencies, profiles, inventories, contracts, GPS jamming, orbital defenses, and SCADA systems.

The gaming resources include a virtual 3d whole earth visualization, including rendering, plotting, and wire framing.

Users launch the missile object by adjusting a position of the gaming client devices for setting parameters of the missile object, including elevation, and azimuth, based on an AR/VR overlay displayed over the gaming client devices.

Still other aspects, features, and advantages of the present invention are readily apparent from the following detailed description, by illustrating a number of illustrative embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings and in which like reference numerals refer to similar elements and in which:

FIG. 1 is a diagram for illustrating systems and methods for employment of augmented reality gaming, including real world geolocation parameters;

FIG. 2 is a detailed diagram for illustrating game client interaction in the systems and methods for employment of augmented reality gaming, including real world geolocation parameters of FIG. 1;

FIG. 3 is a flowchart for describing the systems and methods for employment of augmented reality gaming, including real world geolocation parameters of FIGS. 1-2; and

FIG. 4 is an illustrative visualization of an application for the systems and methods for employment of augmented reality gaming, including real world geolocation parameters of FIGS. 1-3.

### DETAILED DESCRIPTION OF THE PREFERRED EMBODIMENTS

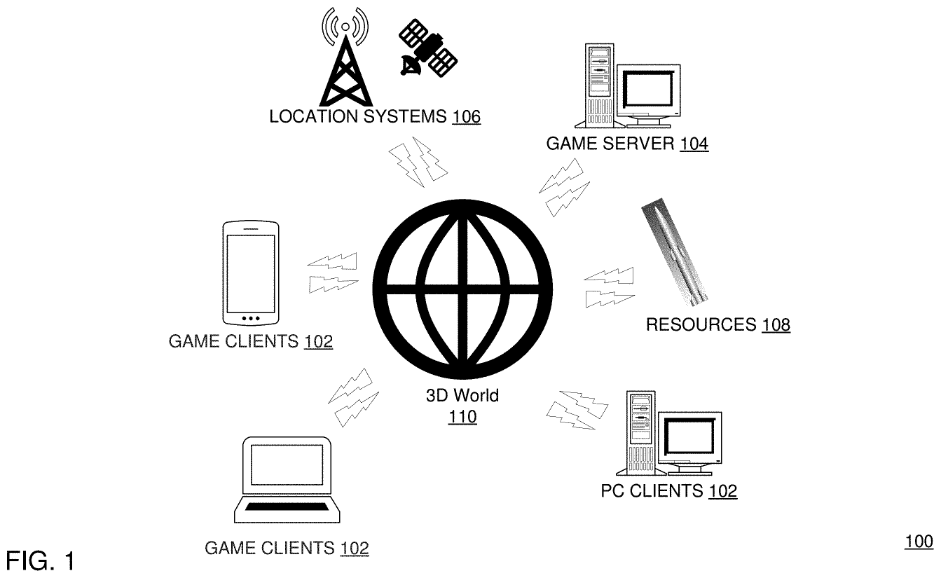

Referring now to the drawings, wherein like reference numerals designate identical or corresponding parts throughout the several views, and more particularly to FIG. 1 thereof, there shown a diagram for illustrating systems and methods for employment of augmented reality gaming, including real world geolocation parameters, and the like.

FIG. 1 is a diagram for illustrating systems and methods for employment of augmented reality gaming, including real world geolocation parameters. In FIG. 1, the system 100 can include PC, smart phone, laptop clients 102, game servers 104, location systems 106 (e.g., global positioning systems, cell tower triangulation, Galileo systems, Glonass systems, Google location services, etc.), gaming resources 108 (e.g., arsenals, tradables, supplies, items, countermeasures, munitions, real and virtual currencies, profiles, inventories, contracts, GPS jamming, orbital defenses, SCADA systems, etc.), and a virtual 3d whole earth visualization 110 (e.g., rendering, plotting, wire framing, etc.).

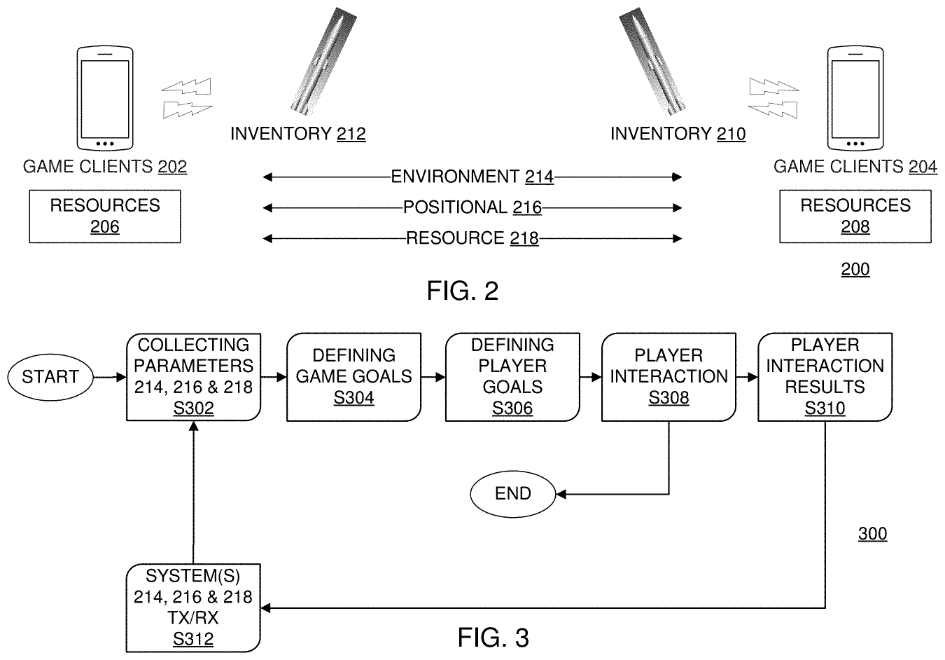

FIG. 2 is a detailed diagram for illustrating game client interaction in the systems and methods for employment of augmented reality gaming, including real world geolocation parameters of FIG. 1. In FIG. 2, the detailed game client interaction 200 can include game clients 202 and 204 having respective resources 206 and 208, as previously described (e.g., arsenals, tradables, supplies, items, countermeasures, munitions, real and virtual currencies, profiles, inventories, contracts, etc.), inventory 210 and 212 from the resources 108 (e.g., missiles, tanks, projectiles, etc.) that get applied against the game clients 202 and 204, based on game parameters transmitted between the game clients 202 and 204, including gaming environment parameters 214 (e.g., virtual, MMO, FPS, missile strike application, battleship application, terrian environment, capture the flag, sink the battleship, bomb the base, etc.), positional parameters 216 (e.g., real world player locations, in-game player positions, etc.), and resource parameters 218, and the like.

FIG. 3 is a flowchart for describing the systems and methods for employment of augmented reality gaming, including real world geolocation parameters of FIGS. 1-2. In FIG. 3, the flowchart can include at step S302 collecting the parameters 214, 216, and 218. In steps S304 and S306, the game and player goals, based on the collected parameters 214, 216, and 218, are defined (e.g., role playing, monetizing, collecting resources, controlling territory, ranking, etc.).

For example, at step S304, character diversity, tactics, and the like, can be employed to provide adverse or advantageous effects, and the like, on the gameplay, such as some wars employing diplomacy as an advantageous affect over pure aggressive actions, and the like. Advantageously, this feature can be employed to allow diversity of garners of all suitable ages, personalities types, and the like, to participate and add to the gameplay. In one example, a spy can provide misinformation to the opposing country or player groups to gain a tactical advantage, missile stockpiling can be employed to counter mutually assured destruction, and the like.

In step S308, players interactions occurs, including launching missiles, capturing territory, performing various types of gameplay, messaging, team and clan building, building expertise, character specialization (e.g., character profiles, such as in arms dealer (legal/illegal), government military, spies, warlords, diplomats, pacts such as NATO, etc.), adding countermeasures, such as orbital watchers, either intel, early warnings or actual measures, and the like, or exiting the game. At step S310, player interaction results are generated, such as results of launching missiles, capturing territory, performing various types of gameplay, messaging, team and clan building, building expertise, character specialization, and the like. At step S312, parameters used by the step S302 are updated to a current state based on the parameters 214, 216, and 218 collected at step S312.

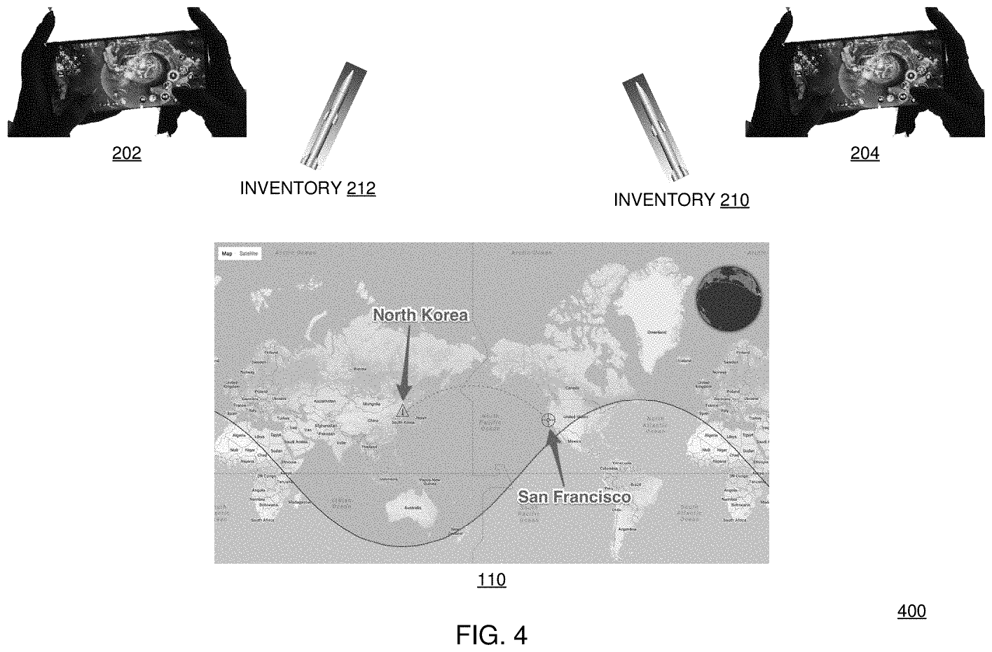

FIG. 4 is an illustrative visualization of an application for the systems and methods for employment of augmented reality gaming, including real world geolocation parameters of FIGS. 1-3. In FIG. 4, is illustrated an augmented reality missile strike game application, including the game clients 202 and 204 launching missiles (e.g., ballistic, non ballistic, etc.) from the respective inventories 210 and 212 at step S308 over the virtual 3d whole earth visualization 110. The player launches a missile by adjusting their devices for setting the missile parameters, for example, to set elevation, azimuth, and the like, based on an AR/VR overlay, and the like as step S310, and which displayed over their respective devices. After the missile is launched, the system updates the parameters at step S312 and determines the results of the missile strike, as previously described.

In further embodiments, the system and method can include local communications, either peer to peer, such as Rogerwilco, Teamspeak, Discourse, or global communication/flagging (e.g., join our group/group calls, etc.)

Advantageously, the illustrative systems and methods, advantageously, provide employment of augmented reality gaming, including real world geolocation parameters, and the like, and the like.

Although the illustrative systems and methods are described in terms of employment of augmented reality gaming, including real world geolocation parameters, and the like, the illustrative systems and methods can be applied to any other suitable types of AR/VR applications, and the like, as will be appreciated by those of ordinary skill in the relevant arts.

While the present inventions have been described in connection with a number of illustrative embodiments, and implementations, the present inventions are not so limited, but rather cover various modifications, and equivalent arrangements, which fall within the purview of the appended claims.

What is claimed is:

1. A computer implemented system for employing augmented reality gaming, including real world geolocation parameters, comprising:
a plurality of gaming client devices;
a game server coupled to the gaming client devices over a communication network;
a geolocation system coupled to the gaming client devices over the communication network; and
gaming resources including a virtual missile object launched by the gaming client devices,
wherein the geolocation system determines a 3D real world location of each of the gaming client devices,
the gaming client devices are positioned by a user in 3D space so as to launch the missile object at an angle and direction estimated to hit another of the gaming client devices,
the game server calculates a real world point of impact based on the angle and direction estimated by the gaming client devices,
the game server determines if the point of impact is considered to hit or miss one of the gaming client devices based on the calculated point of impact and the 3D real world location of each of the gaming client devices, and
the game server displays hits and misses on the gaming client devices.

2. The system of claim 1, wherein the gaming client devices include PCs, smart phones, and laptop clients.

3. The system of claim 1, wherein the geolocation system includes global positioning systems, cell tower triangulation systems, Galileo systems, Glonass systems, Google location services systems.

4. The system of claim 1, wherein the gaming resources include arsenals, tradables, supplies, items, countermeasures, munitions, real and virtual currencies, profiles, inventories, contracts, GPS jamming, orbital defenses, and SCADA systems.

5. The system of claim 1, wherein the gaming resources include a virtual 3d whole earth visualization, including rendering, plotting, and wire framing.

6. The system of claim 1, wherein users launch the missile object by adjusting a position of the gaming client devices for setting parameters of the missile object, including elevation, and azimuth, based on an AR/VR overlay displayed over the gaming client devices.
